(19) United States
(12) Patent Application Publication
(10) Pub. No.: US 2004/0049648 A1
(43) Pub. Date: Mar. 11, 2004

(54) Content recording/playback appratus, and recording medium storing program for content recording/playback

(76) Inventors: Mitsuhiro Sato, Kanagawa (JP); Takashi Shimojima, Tokyo (JP)

Correspondence Address: Gerald Levy, Pitney Hardin Kipp & Szuch, 685 Third Avenue, New York, NY, 10017-4024, US

(21) Appl. No.: 10/466,022

(22) PCT Filed: Apr. 12, 2002
(86) PCT No.: PCT/JP02/03652

(30) Foreign Application Priority Data
Apr. 13, 2001 (JP) 2001-116062

(51) Int. Cl. G06F 12/14

(52) U.S. Cl. 711/164; 707/200

(57) ABSTRACT

The content composed of plural files is configured so as to provide the entire content and the files for composing the content with the usage restriction information.

The content file group management file for managing the file group composing the content, the package management file for managing the files as an integrated package, and the key and usage restriction information recorded in the protected region of the recording medium are provided, and the corresponding relation of the file and package, and the key and usage restriction information is recorded in the content file group management file and package management file, and the usage restriction information is recorded either in each file or the entire content depending on the content, so that the unit of provision/reference of the usage restriction information may be used flexibly and selectively depending on the attributes of the content or the status of use.

### TECHNICAL FIELD

The present invention relates to a method of controlling the usage of content files stored in a recording medium, a content recording and/or playback apparatus for executing this method, and a recording medium recording the program for loading this content usage restriction control method, and, more particularly, to a technique of providing both individual files and the entire content with the usage restriction information when setting the usage restriction to the content composed of plural files.

### BACKGROUND ART

Recently there is a mounting demand for digital content distribution service utilizing communication network or broadcast mediums.

For example, a newspaper article distribution service may be considered, that is, every morning, newspaper articles are downloaded in a portable telephone, and recorded in a recording medium connected to the portable telephone, and the articles may be read whenever desired by connecting the recording medium to a television or other display device. In an electronic book service, for example, a novel is divided into chapters, and the chapter unit is downloaded at a due charge.

In a specific example of newspaper article distribution service, newspaper articles are described in HTML format, and a daily portion of HTML file, and an image file or audio file accompanying this HTML file can be distributed as one package.

When the content is distributed electronically, and recorded in a recording medium, how to prevent unauthorized use of the recorded content and protecting the copyright becomes important. Aside from the mechanism to prevent unauthorized copy and illegal alteration, lately, there has been increasing demand for content usage restriction method which would allow a higher degree of flexibility to control the number of times of viewing or duration of viewing the content.

To realize the usage restriction of the content stored in the recording medium, for example, usage restriction information is recorded in a protected region on the recording medium, and permission or rejection of access to the data on the recording medium is determined by referring to the usage restriction information, or the usage restriction information is individually buried in the content of video or audio, and the use of the content is restricted according to the usage restriction information at the time of use.

In the former method, however, since the usage restriction information cannot be applied individually to all data in the recording medium, the usage restriction cannot be varied from content to content, and the degree of flexibility of content usage restriction is low. In the latter method, since the usage restriction information must be buried in each file, specific control is difficult, for example, the control for limiting the number of times of reading on the whole in the case of a novel divided into files of chapters, or the division of restriction of usage between the entire content and the constituent elements, in the case of newspaper article content composed of one HTML file and one image file, to allow to print the entire article but to prohibit printing of image files individually.

The invention is intended to solve these problems, and it is hence an object thereof to realize a content usage restriction control method of high degree of flexibility by providing the entire content and the individual files for composing the content with the usage restriction information in a content composed of plural files.

### SUMMARY OF THE INVENTION

To achieve the object, in the invention, when recording files of a content composed of plural files in a recording medium, which comprises a content file group management file for managing the file group for composing the content, a package management file for managing the file group as a package, and key and usage restriction information recorded in a protected region in the recording medium, and the corresponding relation between the files and package and the key and usage restriction information is recorded in the content file group management file and package management file, and by recording the usage restriction information either in each file or in the package depending on the content, the provision/reference unit of usage restriction information can be used differently depending on the attributes of the content.

According to the invention, the corresponding relation between the files and package and the key and usage restriction information is recorded in both content file group management files and package management file, and the usage restriction information is recorded in both every file and package, the provision and/or reference unit of usage restriction information can be dynamically changed over depending on the environments of use of the content.

Further, according to the invention, plural files for composing the content are integrated and recorded as an archive file, and by recording the corresponding relation between the archive file and the key and usage restriction information in the package management file, the content distributed in the integrated state can be recorded directly, and the processing efficiency is enhanced, and at the same time the region for recording medium can be saved.

The invention according to claim 1 is a content recording apparatus for recording files of a content composed of plural files in a recording medium, characterized by recording a content file group management file storing management information of plural files for composing the content, recording a package management file for managing the plural files for composing the package as a package, and recording the key and usage restriction information storing both or one of cipher key information and usage restriction information of the files and package in a protected region in the recording medium, in which the corresponding relation between the files and package and the key and usage restriction information is recorded so as to be managed by the content file group management file and package management file, thereby enabling the provision unit of the usage restriction information to be selected properly depending on the attributes of the content.

The invention according to claim 2 relates to the content recording apparatus according to claim 1, in which the package itself and all of plural files for composing the package are recorded so as to correspond to the same key and usage restriction information, and therefore the same usage restriction can be applied to all files in the package.

The invention according to claim 3 relates to the content recording apparatus according to claim 1, in which each one of the plural files for composing the package is recorded so as to correspond to each different key information, and the package itself and all of plural files for composing the package are recorded so as to correspond to the same usage restriction information, and therefore while sharing the usage restriction information, the cipher key is possessed individually, so that the security level can be further enhanced.

The invention according to claim 4 relates to the content recording apparatus according to claim 1, in which the plural files for composing the package are recorded so as to correspond to each different key information, and the package itself and all plural files for composing the package are recorded corresponding to each different key and usage restriction information, and therefore the use of contents can be controlled more specifically by providing the files for composing the content with plural pieces of usage restriction information.

The invention according to claim 5 relates to the content recording apparatus according to any one of claims 1 to 4, in which a directory corresponding to the package is compiled on the recording medium, and all files for composing the package are recorded in the directory, and therefore by making use of the file system structure on the recording medium, the information necessary for package management can be lessened.

The invention according to claim 6 relates to the content recording apparatus according to any one of claims 1 to 5, in which at least one of the content file group management files and package management files is created in a protected region on the recording medium, and therefore the security level can be further enhanced.

The invention according to claim 7 is a content recording apparatus for recording files of a content composed of plural files in a recording medium, characterized by recording plural files for composing the content as an integrated archive file, so as to manage the archive file in a package management file, recording key and usage restriction information storing cipher key information and usage restriction information of the package in a protected region in the recording medium, in which the corresponding relation between the package and the key and usage restriction information can be managed in the package management file, and therefore while providing the entire package with the usage restriction, the region on the recording medium can be saved.

The invention according to claim 8 relates to the content recording apparatus according to claim 7, in which the package management file is created in the protected region on the recording medium, and therefore the security level can be further enhanced.

The invention according to claim 9 is a content playback apparatus for playing back the content from a recording medium recording a content composed of plural files, in which the recording medium stores a content file group management file storing the corresponding relation between the plural files for composing the content and the key and usage restriction information storing both or one of cipher key information and usage restriction information, and a package management file storing the corresponding relation between a package compiling the plural files for composing the content and the key and usage restriction information, with the key and usage restriction information being recorded in the protected region of the recording medium, comprising management information acquiring means for acquiring the corresponding relation between the file or package and the key and usage restriction information from the content file group management file or package management file, key and usage restriction information managing means for acquiring the key and usage restriction information, usage restriction judging means for judging permission or rejection of content playback by referring to the usage restriction information in the key and usage restriction information, content file acquiring means for acquiring the file of the content from the recording medium, and content file playback means for playing back the acquired file of the content, and therefore the content can be played back under a proper usage restriction by referring to the usage restriction information of the file or package. Here in after, the word “playback” means “use of contents” by a user. For example, “playing back a content” includes playing an audio or a video content, viewing an image or a document content, and so forth.

The invention according to claim 10 relates to the content playback apparatus according to claim 9, in which when the content playback is permitted by the usage restriction judging means, the key and usage restriction information managing means updates the usage restriction information of the corresponding content, and the content file acquiring means acquires the content file, then the content file playback means plays back the acquired file of the content, and therefore the restriction of usage can be protected securely by recording the information varying in each playback of content, such as the information of the number of times of use, in the protected region.

The invention according to claim 11 relates to the content playback apparatus according to claim 9 or 10, in which the corresponding relation between the plural files or the package and the key and usage restriction information is recorded in either the content file group management file or the package management file in each content, and the management information acquiring means acquires the corresponding relation with the key and usage restriction information recorded in either the content file group management file or the package management file, and therefore since the usage restriction information to be referred to is established at the stage of content recording, and the content playback process can be simplified.

The invention according to claim 12 is a content playback apparatus for playing back the content from a recording medium recording a content composed of plural files, in which the recording medium stores a content file group management file storing the corresponding relation between the each file composing the content and the key and usage restriction information, and a package management file storing the corresponding relation between a package compiling the plural files for composing the content and the key and usage restriction information, with the key and usage restriction information being recorded in the protected region of the recording medium, comprising management information acquiring means for acquiring the corresponding relation between the file or package and the key and usage restriction information from the content file group management file or package management file, usage restriction selecting means for selecting to use which one of plural pieces of usage restriction information acquired from the management information acquiring means, key and usage restriction information managing means for acquiring the key and usage restriction information, usage restriction judging means for judging permission or rejection of content playback by referring to the usage restriction information in the key and usage restriction information, the content file acquiring means for acquiring the file of the content from the recording medium, and the content file playback means for playing back the acquired file of the content, in which the usage restriction judging means refers to the usage restriction information selected by the usage restriction selecting means, and therefore by providing the usage restriction selecting means, dynamic content usage restriction is realized by selecting the usage restriction depending on the situation of the content playback.

The invention according to claim 13 relates to the content playback apparatus according to claim 12, in which when the content playback is permitted by the usage restriction judging means, the key and usage restriction information managing means updates the usage restriction information of the corresponding content, and the content file acquiring means acquires the content file, then the content file playback means plays back the acquired file of the content, and therefore the restriction of usage can be protected securely by recording the information varying in each playback of content such as the information of the number of times of use in the protected region.

The invention according to claim 14 is a content playback apparatus for playback the content from a recording medium recording a content composed of plural files as one archive file integrating the plural files, in which the recording medium stores a package management file storing the corresponding relation between the archive file and the key and usage restriction information, with the key and usage restriction information being recorded in the protected region of the recording medium, comprising management information acquiring means for acquiring the corresponding relation between the archive file, the key and usage restriction information from the package management file, key and usage restriction information managing means for acquiring the key and usage restriction information, usage restriction judging means for judging permission or rejection of content playback by referring to the usage restriction information in the key and usage restriction information, the content file acquiring means for acquiring the file of the content from the recording medium, and the content file playback means for playing back the acquired archive file of the content, and therefore when playing back each file contained in the archive file, the content can be played back by applying the same usage restriction information.

The invention according to claim 15 relates to the content playback apparatus according to claim 13, in which when the content playback is permitted by the usage restriction judging means, the key and usage restriction information managing means updates the usage restriction information of the corresponding content, and the content file acquiring means acquires the content file, then the content file playback means plays back the acquired file of the content, and therefore the restriction of usage can be protected securely by recording the information varying in each playback of content such as the information of the number of times of use in the protected region.

The invention according to claim 16 to claim 23 is a recording medium which records a program of content control to be executed by a computer in the content playback apparatus and content playback apparatus according to any one of claim 1 to claim 15, and therefore the content use control method can be executed in each apparatus.

The invention according to claim 24 to claim 31is a recording medium which is capable of recording the content, key and usage restriction information, and corresponding relation between the two, in the content recording apparatus in any one of claims 1 to 8. Therefore, by making use of the recording medium such as SD memory card, besides recording data, the security can be assured.

### BRIEF DESCRIPTION OF THE DRAWINGS

FIG. 1 is a block diagram of content recording/playback apparatus in a first embodiment of the invention.

FIG. 2 is a diagram showing an example of packages in the first embodiment of the invention.

FIG. 3 is a diagram showing an example of directory and file configuration in data region 121 of recording medium 120 in the first embodiment of the invention.

FIG. 4 is a diagram of content recording process flow in content recording unit 130 in the first embodiment of the invention.

FIG. 5 is a diagram showing an example of package management file 301 at the stage of recording of package 210 shown in FIG. 2 in the recording medium 120 in the first embodiment of the invention.

FIG. 6 is a diagram showing an example of content file group management file 303 at the stage of recording of package 210 shown in FIG. 2 in the recording medium 120 in the first embodiment of the invention.

FIG. 7 is a diagram showing an example of package management file 301 at the stage of recording of package 220 shown in FIG. 2 in the recording medium 120 in the first embodiment of the invention.

FIG. 8 is a diagram showing an example of content file group management file 305 at the stage of recording of package 220 shown in FIG. 2 in the recording medium 120 in the first embodiment of the invention.

FIG. 9 is a diagram showing the correspondence of each package, each content file contained therein, and key and usage restriction information, at the stage of reading in the recording medium 120 after completion of all content recording processes shown in FIG. 4 in two packages shown in FIG. 2 in the first embodiment of the invention.

FIG. 10 is a diagram showing content playback process flow in content playback unit 140 in the first embodiment of the invention.

FIG. 11 is a configuration diagram of content recording/playback apparatus in a second embodiment of the invention.

FIG. 12 is a diagram showing an example of a package in the second embodiment of the invention.

FIG. 13 is a diagram showing an example of directory and file configuration in data region 121 of recording medium 120 when the package shown in FIG. 12 is recorded by content recording unit 130 in the second embodiment of the invention.

FIG. 14 is a diagram of content recording process flow in content recording unit 130 in the second embodiment of the invention.

FIG. 15 is a diagram showing an example of package management file 1301 at the stage of recording of package 1210 shown in FIG. 12 in the recording medium 120 in the second embodiment of the invention.

FIG. 16 is a diagram showing an example of content file group management file 1303 at the stage of recording of package 1210 shown in FIG. 12 in the recording medium 120 in the second embodiment of the invention.

FIG. 17 is a diagram showing the correspondence of each package, each content file contained therein, and key and usage restriction information, at the stage of reading in the recording medium 120 after completion of all content recording processes shown in FIG. 14 in the package shown in FIG. 12 in the second embodiment of the invention.

FIG. 18 is a diagram showing content playback process flow in content playback unit 140 in the second embodiment of the invention.

FIG. 19 is a diagram showing an example of directory and file configuration in data region 121 of recording medium 120 when two packages shown in FIG. 2 are recorded by content recording unit 130 in a third embodiment of the invention.

FIG. 20 is a diagram of content recording process flow in content recording unit 130 in the third embodiment of the invention.

FIG. 21 is a diagram showing the correspondence of each package, each content file contained therein, and key and usage restriction information, at the stage of reading in the recording medium 120 after completion of all content recording processes shown in FIG. 20 in two packages shown in FIG. 2 in the third embodiment of the invention.

FIG. 22 is a diagram showing content playback process flow in content playback unit 140 in the third embodiment of the invention.

FIG. 23 is a diagram showing an example of a package in a fourth embodiment of the invention.

FIG. 24 is a diagram showing an example of directory and file configuration in data region 121 of recording medium 120 when two packages shown in FIG. 23 are recorded by content recording unit 130 in the fourth embodiment of the invention.

FIG. 25 is a diagram showing correspondence of each package, each content file contained therein, and key and usage restriction information, at the stage of reading in the recording medium 120 after completion of all content recording processes shown in FIG. 4 in two packages shown in FIG. 23 in the fourth embodiment of the invention.

FIG. 26 is a diagram showing content playback process flow in content playback unit 140 in the fourth embodiment of the invention.

### BEST MODE FOR CARRYING OUT THE INVENTION

(First Embodiment)

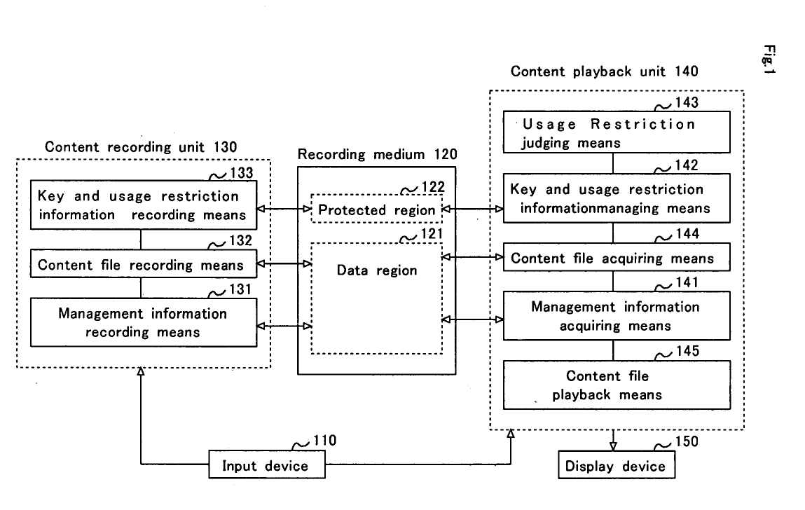

FIG. 1 is a block diagram of content recording/playback apparatus in a first embodiment of the invention. The content recording/playback apparatus shown in FIG. 1 comprises input device 110, recording medium 120, content recording unit 130, content playback unit 140, and display device 150.

The input device 110 is used by the user when requesting content recording and requesting content playback.

The recording medium 120 is composed of a data region 121 used for storing content file of package unit and its management information, and a protected region 122 used for storing cipher key for encrypting the content files stored in the data region 121 and usage restriction information. Herein, the protected region 122 is a special protected region in which the user cannot read or write directly. Unless mutually validated with the content recording/playback apparatus, the protected region cannot be read or written from the content recording/playback apparatus. “Mutual validation” is confirmation of authenticity between two objects. Herein, the protected region and the content recording/playback apparatus validate mutually by identification number, electronic signature or the like to recognize each device is duly authorized.

The content recording unit 130 is to process recording of content of package unit in the recording medium 120, and it is composed of management information recording means 131, content file recording means 132, and key and usage restriction information recording means 133.

The management information recording means 131 records package management information for managing the package recorded in the data region 121 of the recording medium 120, and content file group management information for managing the content files included in the package.

The content file recording means 132 records each content file main body of content file group included in the package in the data region 121 of the recording medium 120.

The key and usage restriction information recording means 133 records one or both of the information about the usage restriction of the entire package or individual content files included in the package, and the cipher key for encrypting each content file, in the protected region 122 of the recording medium 120. The usage restriction information is the information about the limitation of the number of times allowed to play back, move, copy or print the content.

In the following explanation, both the usage restriction information and the cipher key are supposed to be recorded. If the usage restriction information is not recorded, it is assumed that there is no usage restriction, and if the cipher key is not recorded, it is assumed that the content file is not encrypted.

The content playback unit 140 is to play back the content recorded in the recording medium 120, and it is composed of management information acquiring means 141, key and usage restriction information managing means 142, usage restriction judging means 143, content file acquiring means 144, and content file playback means 145.

The management information acquiring means 141 acquires the package management file and content file group management file from the data region 121 of the recording medium 120.

The key and usage restriction t information managing means 142 acquires the designated cipher key and usage restriction information from the protected region 122 of the recording medium 120, updates the usage restriction information in relation to content playback, and records the updated usage restriction information in the protected region 122.

The usage restriction judging means 143 checks the usage restriction to establish whether the content can be played back or not when playing back the content file.

The content file acquiring means 144 receives a content file acquisition instruction, and acquires the designated file from the data region 121 of the recording medium.

The content file playback means 145 decrypts and plays back the content file when the content file playback is permitted as a result of checking of usage restriction by the usage restriction judging means 143, and issues to the display device 150.

The display device 150 is used in output of content file by the content playback unit 140.

In this embodiment, specific examples of the content recording process and content playback process in consideration of the usage restriction information of content are explained below.

<Content Recording Process>

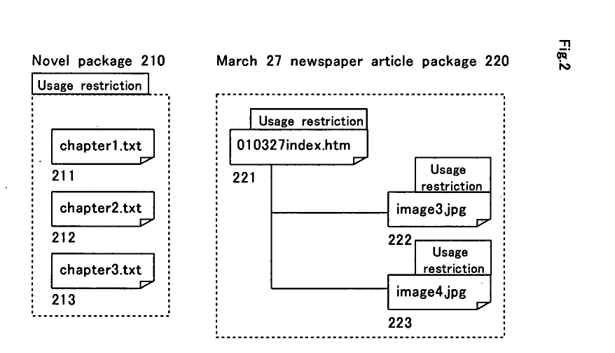

In the first place, an instruction of content recording is received through the input means 110. At this time, suppose a recording instruction of two packages as shown in FIG. 2 is given.

FIG. 2 shows a novel package 210 composed of text files 211, 212 and 213, and a March 27 newspaper article package 220 composed of HTML file 221, and image files 222 and 223.

The text files 211, 212 and 213 have file names chapter1.txt, chapter2.txt, and chapter3.txt, respectively. It is a package composed of chapter 1, chapter 2, and chapter 3 of a novel as individual text files. In this novel package 210, the usage restriction is not set to each content file in the package, and the usage restriction is set only on the entire package 210.

The HTML file 221 has a file name of 010327index.htm, and an image file 222 in the file name of image3.jpg and an image file 223 in the file name of image4.jpg are buried. In this March 27 newspaper article package 220, the usage restriction is set to each content file in the package, but the usage restriction is not set in the entire package 220. Thus, in this embodiment, it is assumed that the usage restriction is set either in the entire package or in individual content files in the package.

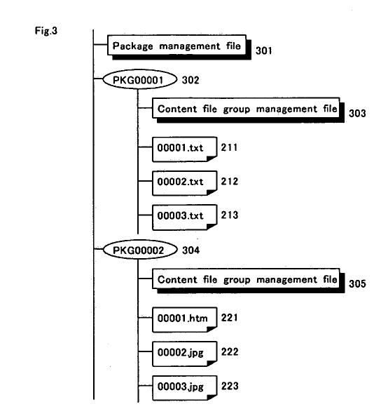

FIG. 3 is a diagram showing an example of directory and file configuration in the data region 121 of the recording medium 120 when the two packages shown in FIG. 2 are recorded by the content recording unit 130. In the same layer as the package management file 301, a directory 302 called PKG00001 and a directory 304 called PGK00002 are created. Beneath the directory 302, a content file group management file 303 and a file included in the package 210 shown in FIG. 2 are created. The text files 211, 212, 213 included in the package 210 shown in FIG. 2 are supposed to be recorded in the file names 00001.txt, 00002.txt, and 00003.txt, respectively. Similarly, beneath the directory 304, a content file group management file 305 and a file included in the package 220 shown in FIG. 2 are created. The HTML file 221 and image files 222, 223 included in the package 220 in FIG. 2 are supposed to be recorded in the file names 00001.htm, 00002.jpg, and 00003.jpg, respectively.

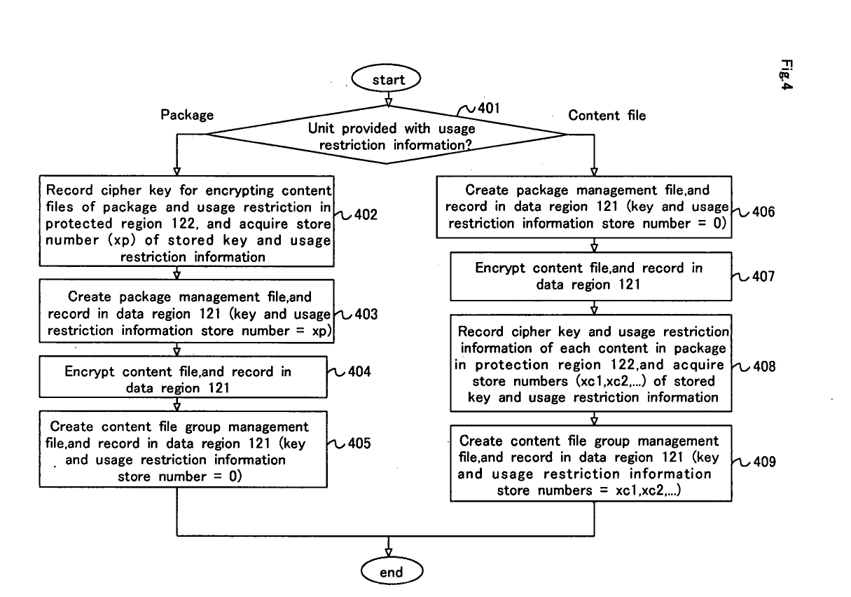

FIG. 4 is a diagram of content recording process flow in the content recording unit 130 in the first embodiment. Recording process of two packages shown in FIG. 2 is explained below while referring to FIG. 4. First, recording process of the package 210 is explained.

Step 401: The content recording unit 130 receives a content recording instruction from the input means 110, and checks if the usage restriction providing unit of the package is set to the entire package or in the individual content files in the package. In the case of the package 210, since the restriction is set to the entire package, the process goes to step 402. If given in the individual content files in the package, the process goes to step 406.

Step 402: A cipher key for encrypting the content in the package is generated, and the cipher key and the usage restriction information of the entire package are recorded in the protected region 122 of the recording medium 120 by the key and usage restriction information recording means 133, and the store number (supposing this key and usage restriction information store number to be xp) of the stored key and usage restriction information is acquired. Herein, the key and usage restriction information store number is the number given to each storing region of the set of the cipher key and usage restriction information recorded in the protected region 122.

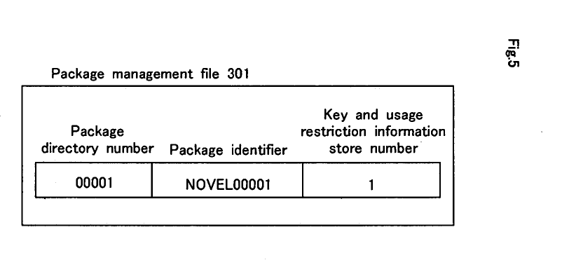

Step 403: The management information recording means 131 creates or updates the package management file, and records in the data region 121 of the recording medium 120. FIG. 5 is a diagram showing an example of package management file 301 at the stage of recording of the package 210 shown in FIG. 2 in the recording medium 120. The package management file 301 manages the correspondence of the package directory number corresponding to the package directory name, the package identifier for identifying the directory, and the key and usage restriction information store number of the package. Herein, as the key and usage restriction information store number, the value (=xp) obtained at step 402 is recorded. As shown in FIG. 3, meanwhile, in this embodiment, the directory name of the package directory corresponding to the package directory number is supposed to be “PKGxxxxx (xxxxx=package directory number) according to the appellation rule. However, the appellation rule is not particularly specified as far as the directory name of the package directory can be identified from the package directory number. In FIG. 5, the package identifier is a character string of “NOVEL00001”, but the package identifier may be any character string, numerals or symbols as far as the package directory existing in the data region 121 of the recording medium 120 can be identified.

Step 404: The content file recording means 132 encrypts each content file in the package using the cipher key generated at step 402, and records in the data region 121 of the recording medium 120.

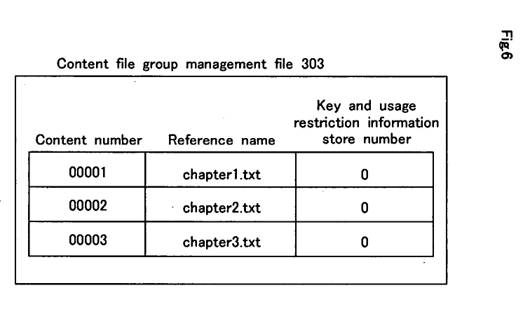

Step 405: The content file recording means 132 creates a content file group management file, and records in the data region 121 of the recording medium 120. FIG. 6 is a diagram showing an example of content file group management file 303 at the stage of recording of the package 210 shown in FIG. 2 in the recording medium 120. The content file group management file manages the correspondence of the content number corresponding to the file name when recording in the data region 121 of the recording medium 120, the reference name when this content is linked from another content, and the cipher key and usage restriction information of the content file, and one is created in every package directory. The content number is given in the package unit. As shown in FIG. 3, in the embodiment, the content file name corresponding to the content number is supposed to be “xxxxx.EXT (xxxxx=content number, EXT=extension) according to the appellation rule. However, the appellation rule is not particularly specified as far as the content file name can be identified on the data region 121 of the recording medium 120 from the content number. Herein, the key and usage restriction information store number of each content are all filled with zero.

Next, the recording process of the package 220 is explained. In the case of the package 220, since the usage restriction is set to each content file in the package, the process skips from step 401 to step 406.

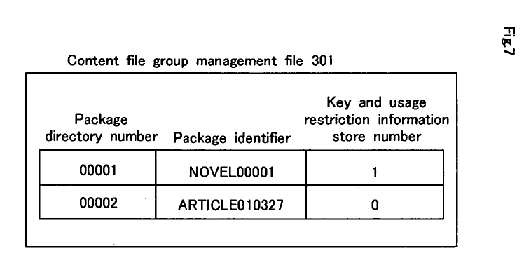

Step 406: The management information recording means creates or updates the package management file, and records in the data region 121 of the recording medium 120. FIG. 7 is a diagram showing an example of package management file 301 at the stage of recording of the package 220 shown in FIG. 2 in the recording medium 120. Herein, since the usage restriction is not set to the entire package 210, zero is recorded in the key and usage restriction information store number of the corresponding entry.

Step 407: The content file recording means 132 generates a cipher key in each content file in the package, encrypts the files using the generated cipher key, and records in the data region 121 of the recording medium 120.

Step 408: The key and usage restriction information recording means 133 records the usage restriction information and the cipher key generated at step 407 in the protected region 121 of the recording medium 120 as a set to each corresponding content file, and acquires the store number of the stored key and usage restriction information (supposing to be xc1, xc2, . . . , respectively).

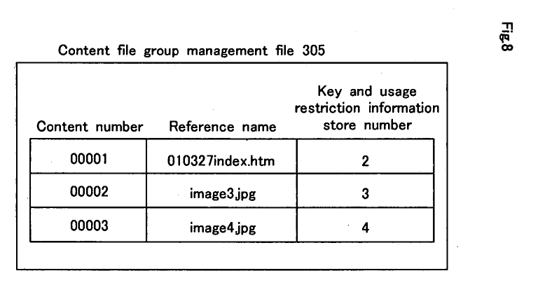

Step 409: The management information recording means 131 creates a content file group management file, and records in the data region 121 of the recording medium 120. FIG. 8 is a diagram showing an example of content file group management file 305 at the stage of recording of the package 220 shown in FIG. 2 in the recording medium 120. Herein, as the key and usage restriction information store number of each content, the values (=xc1, xc2, . . . ) acquired at step 408 are recorded.

In the content recording process, the cipher key and usage restriction information are recorded in the protected region, and in this case it is required that the mutual validation is established between the recording medium having this protected region and the content recording apparatus accessing this recording medium. That is, the recording process can be executed only when the identification number of the content recording unit 130 and the identification number of the recording medium 120 are recognized to be suitable and the access right is confirmed. This is the same in the content recording process in the following embodiments.

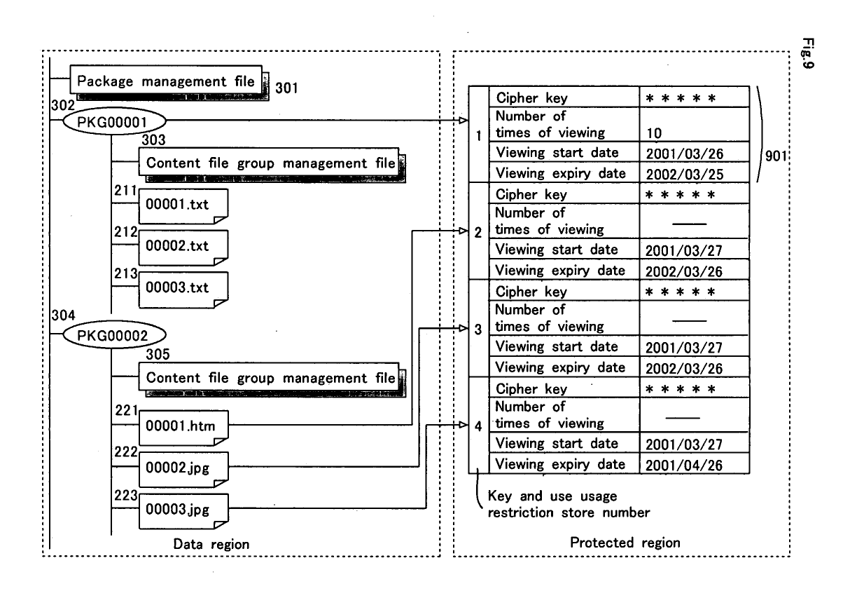

FIG. 9 is a diagram showing the correspondence of each package, each content file contained herein, and the key and usage restriction information, at the stage of recording in the recording medium 120 after completion of content recording process shown in FIG. 4 in the two packages shown in FIG. 2.

As the usage restriction information, FIG. 9 describes three types of usage restriction, that is, the number of times of viewing, viewing start date, and viewing expiry date. Herein, the number of times of viewing is the limit number of times allowed to view the content file. The viewing start date is the first day and time allowed to view the content file. The viewing expiry date is the final day and time allowed to view the content file. In the embodiment shown in FIG. 9, three types of usage restriction are presented, but this is only an example of usage restriction, and not limited to these three types of usage restriction, other usage restrictions may also be set.

For example, the number of times allowed to move, number of times allowed to copy, or number of times allowed to print may be set. That is, the number of times allowed to move, number of times allowed to copy, and number of times allowed to print are the limited times of moving, copying and printing the content file. Specifically, when copying the content file in a folder or the like, if the number of times of copying is set at 2 times, and if already copied once, when copied one more time, subsequent copying is prohibited.

The cipher key and usage restriction information recorded in the protected region, and the package or content file recorded in the data region correspond to each other. Each package or content file is related to the key and usage restriction information store number. Further, as shown in FIG. 9, each key and usage restriction information store number corresponds to the key and usage restriction information such as the number of times of viewing. Therefore, the cipher key and usage restriction information recorded in the protected region and the package or content file recorded in the data region have a corresponding relation by way of the key and usage restriction information store number.

<Content Playback Process>

Suppose playback (viewing) of text file 211 shown in FIG. 3 is requested through the input means 110.

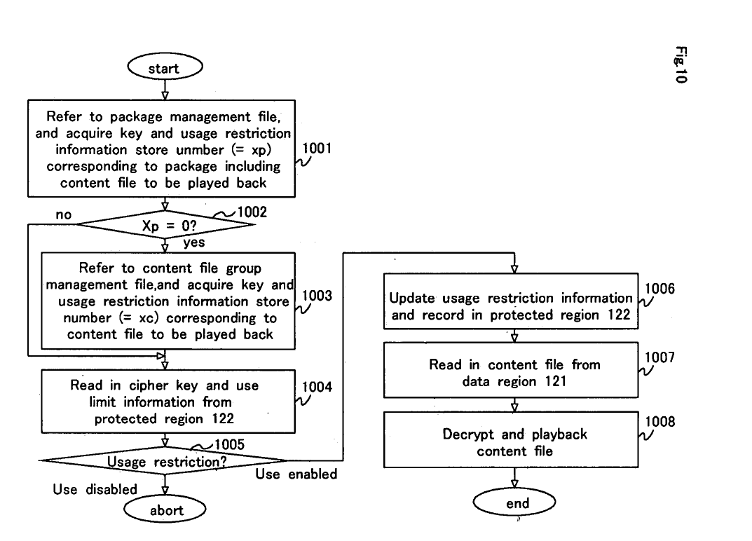

FIG. 10 is a flowchart of content playback process in the content playback unit 140 in the first embodiment. Playback process of the text file 211 is explained below while referring to FIG. 10.

Step 1001: The content playback unit 140 receives a playback request from the input means 110, and refers to the package management file in the management information acquiring means 141, and acquires the key and usage restriction information store number (=xp) corresponding to the package including the content file of which playback is instructed. In the case of the text file 211, the key and usage restriction information store number (=1) corresponding to the package directory number 00001 is acquired from the package management file 301 (FIG. 7).

Step 1002: If the value of the key and usage restriction information store number acquired at step 1001 is “0”, the process goes to step 1003, and if other than “0”, the process goes to step 1004. In this example, the value acquired at step 1001 is “1”, and the process goes to step 1004.

Step 1003: The management information acquiring means 141 refers to the content file group management file in the same directory as the content file of this playback is instructed, and acquires the key and usage restriction information store number (=xc) of the content file.

Step 1004: The key and usage restriction information managing means 142 reads the cipher key and usage restriction information stored in the region corresponding to the key and usage restriction information store number acquired at the preceding step. Herein, the key and usage restriction information store number is the same number (xp) if the key and usage restriction information store number acquired at step 1001 is other than “0” and if “0”, the value (xc) acquired at step 1003 is used. In this example, the region 901 in FIG. 9 is read in.

Step 1005: The usage restriction judging means 143 checks the usage restriction information acquired at step 1004. In this example, since the number of times of viewing, viewing start date, and viewing expiry date are set as the usage restriction information, the process is interrupted and content file is not played back unless the number of times of viewing is 0 or more, and the present date intended to play back is after the viewing start date and before the viewing expiry date.

Step 1006: When playing back the content file, if including the usage restriction information required to be updated, the key and usage restriction information managing means 142 updates the usage restriction information, and overwrites on the protected region 122. In the case of the usage restriction information in this example, since the number of times viewing must be decreased by one, the value in the field 901 of number of times of viewing in FIG. 9 is replaced by “9”.

Step 1007: The content file acquiring means 144 acquires the content file.

Step 1008: The content file playback means 145 decrypts and plays back the content file acquired at step 1007 by using the cipher key acquired at step 1004, and issues to the display device 150.

In the content playback process, the cipher key and usage restriction information recorded in the protected region are obtained, and in this case it is required that the mutual validation is established between the recording medium having this protected region and the content playback apparatus accessing this recording medium. That is, the playback process can be executed only when the identification number of the content playback unit 140 and the identification number of the recording medium 120 are recognized to be suitable and the access right is confirmed. This is the same in the content playback process in the following embodiments.

So far is explained the playback process of the text file 211. In this example of novel package, since the usage restriction is set to the entire package, it is possible to set the usage restriction so as to prohibit viewing of all content files included in the package 210 when the total number of times of viewing the text file of each chapter in the package has reached 10 times.

Thus, in this embodiment, when recording files of the contents composed of plural files in the recording medium, a content file group management file for managing the files composing the content, a package management file for managing the file groups as package, and key and usage restriction information recorded in the protected region of the recording medium are provided, and the relation between content file or package and key and usage restriction information is recorded in the content file group management file and package management file depending on the content, so that the provision/reference unit of key and usage restriction information can be used differently depending on the attributes of the content.

In this embodiment, when recording the content file in which the usage restriction is set, since it is encrypted, it can be played back only when the usage restriction is checked and the content file is decrypted in the content playback unit 140.

As the example of content file, in the embodiment, the text file, HTML file, and image file are shown, but the content file may be a file of any other format.

Also in the embodiment, the package management file and content file group management file are recorded in the data region 121 of the recording medium 120, but these management files may be also recorded in the protected region 122. As a result, risk of illegal alteration of management file by ill-willed user can be lowered, thus heightening security.

When recording the content, in the embodiment, at step 405 in FIG. 4, by setting the key and usage restriction information store number to be recorded in the content file group management file in the value (=xp) acquired at step 402 instead of “0”, it is enough to process after step 1003 in FIG. 10 when playing back the content, and the efficiency of playback process can be enhanced.

Still more, in the embodiment, when recording the content, even if the usage restriction information provision unit at step 401 in FIG. 4 is the package unit, the key for encrypting the content file can be generated individually, and stored in the protected region 122, and by storing each key and usage restriction information store number in the content file group management file at step 405, the security can be enhanced as compared with the case of using the same cipher key in all content files in the packages.

(Second Embodiment)

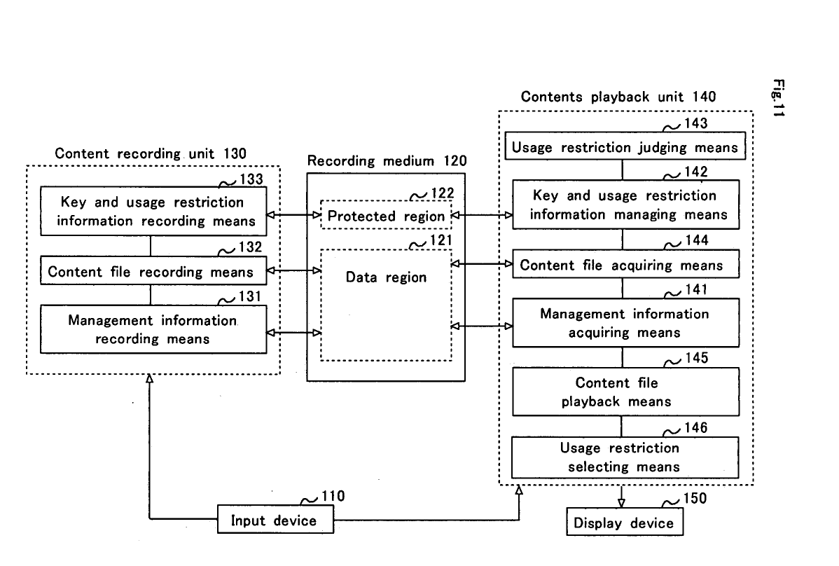

A second embodiment is explained below. A configuration of content recording/playback apparatus in the second embodiment is shown in FIG. 11, which is similar to the configuration of the first embodiment (FIG. 1), except that the usage restriction selecting means 146 is added in the content playback unit 140. In this embodiment, different from the first embodiment, it is assumed that the usage restriction is set to both the entire package and the individual content files in the package.

The content recording process and content playback process in the second embodiment are explained below by referring to specific examples.

<Content Recording Process>

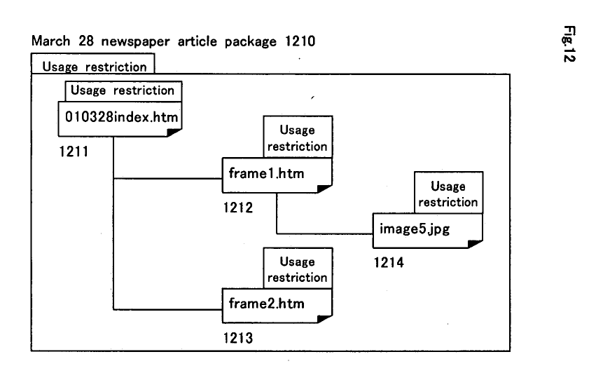

In the first place, a content recording instruction is received through the input means 110. At this time, suppose a recording instruction of a newspaper article package, as shown in FIG. 12, is given.

FIG. 12 shows a March 28 newspaper article package 1210 composed of HTML files 1211, 1212, 1213, and image file 1214. The HTML file 1211 is a frame definition file, and HTML files 1212 and 1213 are contained as frame cells. The image file 1214 is buried in the HTML file 1212. In the March 28 newspaper article package 1210, the following usage restrictions are set.

a) The viewing start date of entire package and each content file in the package is [2001/03/28].

b) When playing back each content file in the package individually, the viewing expiry date is not set (the user is allowed to view any time after viewing start date).

c) When the entire package is regarded as one content, the viewing expiry date is [2001/04/27].

d) The number of times of viewing is not limited.

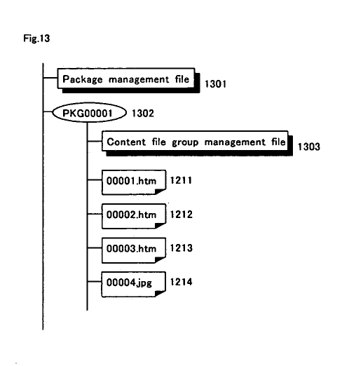

FIG. 13 is a diagram showing an example of directory and file configuration in the data region 121 of the recording medium 120 when the package shown in FIG. 12 is recorded by the content recording unit 130. Suppose the HTML files 1211, 1212, 1213 and image file 1214, included in the package 1210 in FIG. 12, are recorded in the file names of 00001.htm, 00002.htm, 00003.htm, and 00004.jpg, respectively.

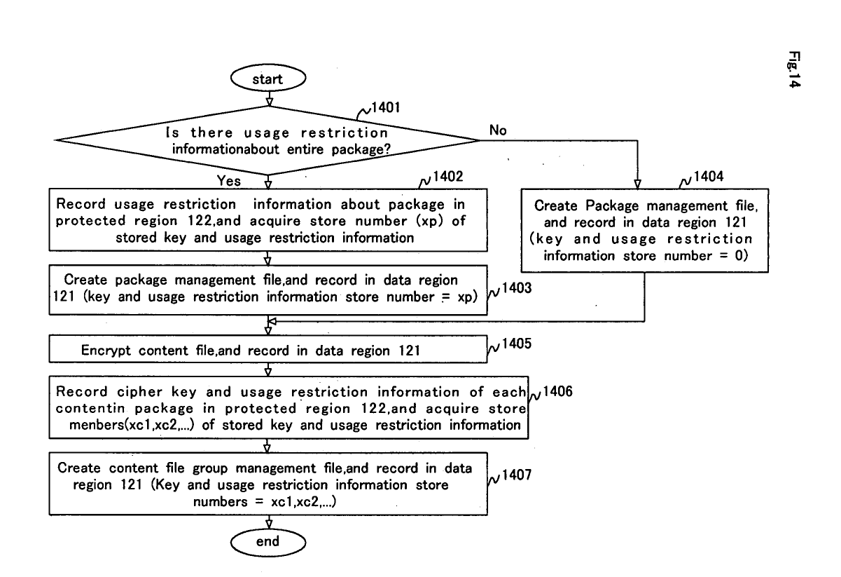

FIG. 14 is a flowchart of content recording process in the content recording unit 130 in the second embodiment. The recording process of the package shown in FIG. 12 is explained by referring to FIG. 14.

Step 1401: The content recording unit 130 receives an instruction of content recording from the input means 110, and checks if the usage restriction is set to the entire package or not. In the case of the package 1210, the usage restriction is set also in the entire package, the process goes to step 1402. If the usage restriction is not set to the entire package, the process goes to step 1404.

Step 1402: The key and usage restriction information recording means 133 records the usage restriction information of the entire package in the protected region 122 of the recording medium 120, and acquires the store number (=xp) of the stored usage restriction information. Different from step 402 in FIG. 4 in the first embodiment, cipher key is not stored in the region corresponding to the key and usage restriction information store number xp.

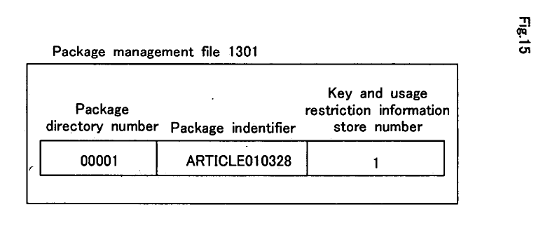

Step 1403: The process is same as at step 403 in FIG. 4 of the first embodiment, and the detail is omitted. FIG. 15 is a diagram showing an example of package management file 1301 at the stage of recording the package 1210 shown in FIG. 12 in the recording medium 120. Herein, as the key and usage restriction information store number, the value (=xp) acquired at step 1402 is recorded.

Step 1404: The process is same as at step 406 in FIG. 4 of the first embodiment, and the detail is omitted.

Step 1405: The process is same as at step 407 in FIG. 4 of the first embodiment, and the detail is omitted.

Step 1406: The process is same as at step 408 in FIG. 4 of the first embodiment, and the detail is omitted.

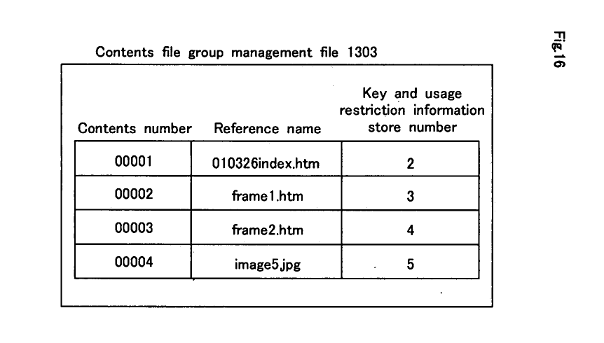

Step 1407: The process is same as at step 409 in FIG. 4 of the first embodiment, and the detail is omitted. FIG. 16 is a diagram showing an example of content file group management file 1303 at the stage of recording the package 1210 shown in FIG. 12 in the recording medium 120.

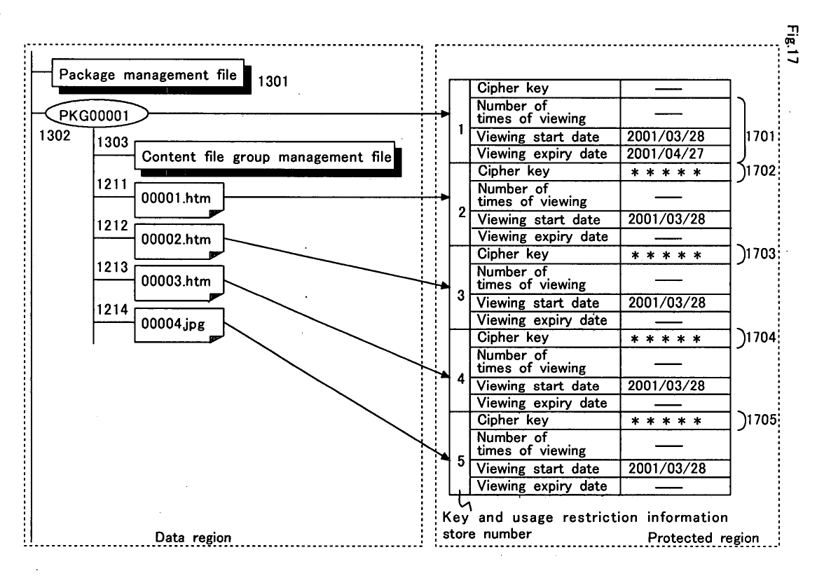

FIG. 17 is a diagram showing correspondence of package, each content file contained therein, and key and usage restriction information at the stage of recording in the recording medium 120, after completion of all of content recording processes shown in FIG. 14 in the package shown in FIG. 12.

<Content Playback Process>

Suppose playback (viewing) of image file 1214 shown in FIG. 13 alone is requested through the input means 110.

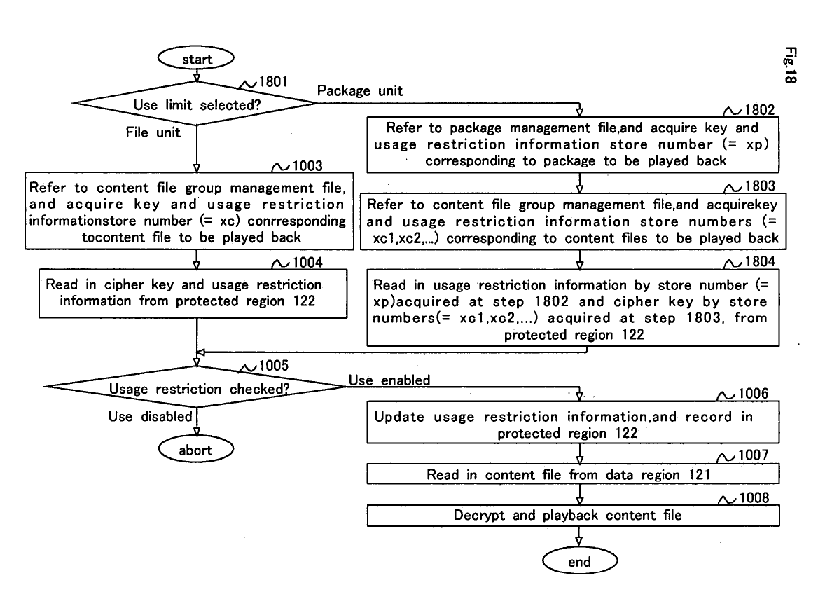

FIG. 18 is a flowchart of content playback process in the content playback unit 140 in the second embodiment. The playback process of viewing this image file 1214 alone is explained below by referring to FIG. 18.

Step 1801: The content playback unit 140 receives a playback request of content from the input means 110, and the usage restriction selecting means 146 selects which usage restriction information is applied depending on whether the playback unit plays the content file unit or the entire package composed of one or more content files. In this example, since it is a playback request in the image file 1214 alone, the process goes to step 1003 and on. That is, when the playback is requested to play back the content file alone, the same process following step 1003 of the content playback process flow in FIG. 10 in the first embodiment is executed.

Suppose the playback is requested to play back the entire package composed of four content files shown in FIG. 12. At this time, after step 1801, the process goes to step 1802.

Step 1802: The management information acquiring means 141 refers to the package management file, and acquires the key and usage restriction information store number (=xp) corresponding to the package to be played back. In this example, referring to the package management file 1301 (FIG. 15), the key and usage restriction information store number (=1) is acquired.

Step 1803: The management information acquiring means 141 refers to the content file group management file corresponding to the content file for composing the package to be played back, and acquires the key and usage restriction information store numbers (=xc1, xc2, . . . ) corresponding to the content file. In this example, referring to the content file group management file 1303 (FIG. 16), the corresponding key and usage restriction information store numbers (=2, 3, 4, 5) are acquired.

Step 1804: The key and usage restriction information managing means 141 reads the usage restriction information stored in the region corresponding to the key and usage restriction information store number (=xp) acquired at step 1802, and the cipher key stored in the corresponding regions of the key and usage restriction information store numbers (=xc1, xc2, . . . ) acquired at step 1803. In this example, the region 1701 in FIG. 17 is read in as the usage restriction information, and the regions 1702, 1703, 1704, and 1705 are read as the cipher keys.

The subsequent process is the same as the process of step 1005 to step 1008 in FIG. 10 in the first embodiment, and the detail is omitted.

Thus, in this embodiment, the corresponding relation of the file, package, and key and usage restriction information is recorded in the content file group management file and package management file, and the usage restriction information is recorded corresponding to both every file and package, and therefore the provision/reference unit of the usage restriction information can be dynamically changed over depending on the environments of the use of the content.

(Third Embodiment)

A third embodiment of the invention is explained. In the third embodiment, the configuration of the content recording/playback apparatus is same as in the first embodiment (FIG. 1). However, that which differs from the first embodiment is that plural content files for composing the package are integrated and recorded as one archive file in the content file recording means 132, and that the content file playback means 145 has a function of playback after-extracting the decrypted archive file.

The content recording process and content playback process in the third embodiment are explained. Herein, the same as in the first embodiment, when recording two packages shown in FIG. 2, are suppose to record the novel package 210 as an archive file.

<Content Recording Process>

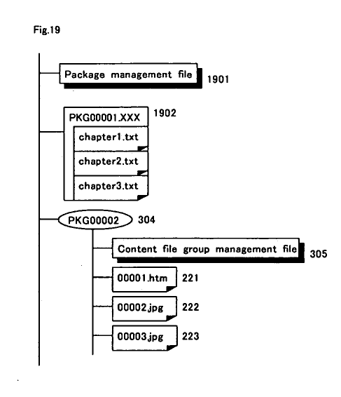

FIG. 19 is a diagram showing an example of directory and file configuration in the data region 121 of the recording medium at the time of recording of two packages shown in FIG. 2 by the content recording unit 130. PKG00001.XXX 1902 is an archive file composed by archiving and integrating plural files chapter1.txt, chapter2.txt, and chapter3.txt.

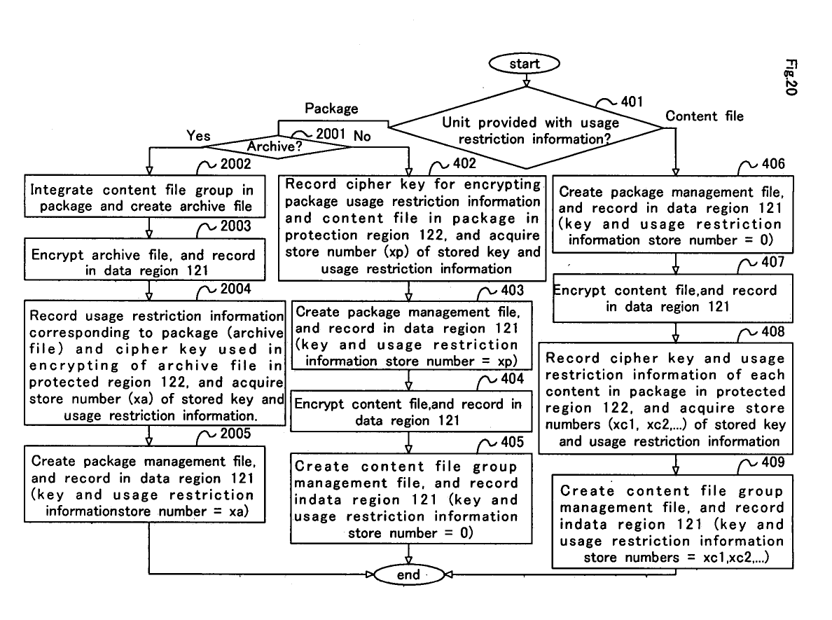

FIG. 20 is a diagram of content recording process flow in the content recording unit 130 in the third embodiment. The process of recording the package in the data region 121 without converting it into an archive file is same as in the first embodiment, and the detail is omitted. The process of integrating the novel package 210 into an archive file is explained below.

In the novel package 210, the usage restriction is set to the package unit, and therefore the process goes from step 401 to step 2001.

Step 2001: The process goes to step 2002 when converting the package into an archive, and otherwise to process 402.

Step 2002: The content file recording means 132 integrates the content files in the package, and compiles an archive file.

Step 2003: The content file recording means 132 generates a cipher key, encrypts the archive file using the generated cipher key, and records in the data region 121 of the recording medium 120.

Step 2004: The key and usage restriction information recording means 133 records the usage restriction information about the package, and the cipher key generated at step 2003 in the protected region 122 of the recording medium 120, and acquires the store number (=xa) of the stored key and usage restriction information.

Step 2005: The management information recording means 131 creates a package management file, and records in the data region 121 of the recording medium 120. In this example, the package management file 1901 has the same content as the package management file 301 shown in FIG. 5 in the first embodiment.

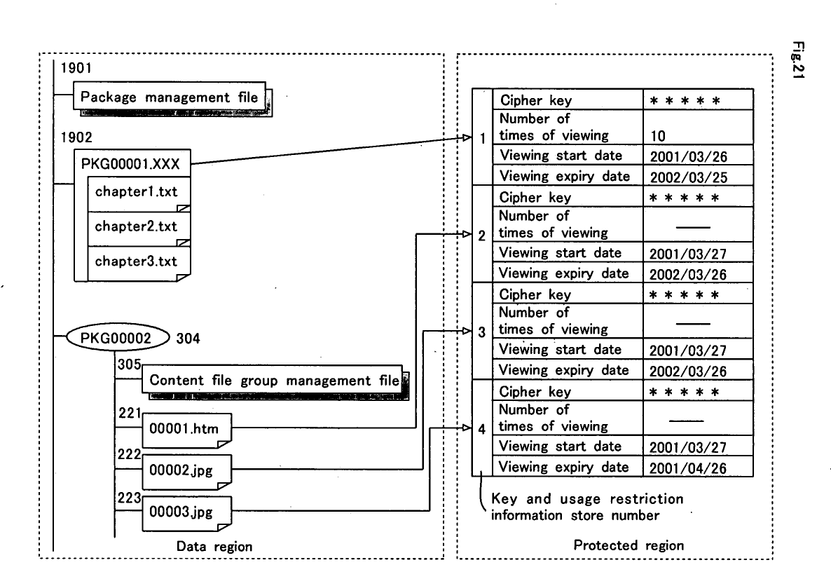

FIG. 21 is a diagram showing correspondence of each package, each content file contained therein, and key and usage restriction information, at the stage of reading in the recording medium 120 after completion of all content recording processes shown in FIG. 20 in two packages shown in FIG. 2 in the third embodiment. When compared with FIG. 9 in the first embodiment, it is known that the correspondence of the novel package 210 and key and usage restriction information is not different between the two embodiments.

<Content Playback Process>

Suppose playback (viewing) of text file 211 in the novel package 210 is requested through the input means 110.

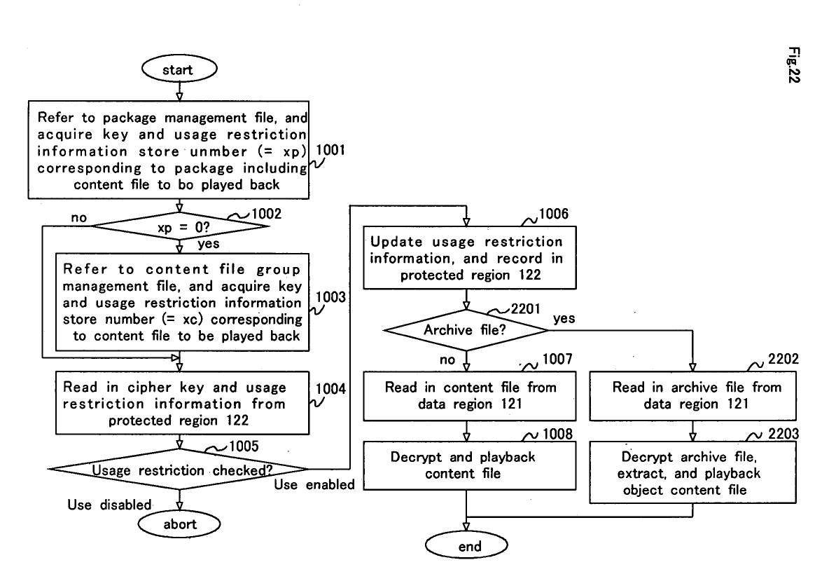

FIG. 22 is a flowchart of the content playback process in the content playback unit 140 in the third embodiment. The playback process of the text file 211 is explained according to FIG. 22.

The process from step 1001 to step 1006 is same as the process in FIG. 10 in the first embodiment, and the explanation is omitted.

Step 2201: When the package including the content file of which playback is requested is recorded in the recording medium 120 as an archive file, the process goes to step 2202, otherwise to step 1007.

Step 2202: The content file acquiring means 144 acquires the archive file including the content file.

Step 2203: The content file playback means 145 decrypts the archive file acquired at step 2202 by using the cipher key acquired at step 1004, extracts the archive file, plays back the intended content file, and issues to the display device 150.

Thus, in this embodiment, plural files composing the content are recorded as an integrated archive file, and the correspondence between the archive file and the key and usage restriction information is recorded in the package management file, and the content to be distributed in integrated state is recorded in the state unchanged, and therefore the processing efficiency is enhanced and the region of the recording medium can be saved.

In this embodiment, since the archive file converted from the package of which use is limited is encrypted when recording, it can be played back only when the usage restriction is checked and the archive file is decrypted by the content playback unit 140.

As the example of content file, in the embodiment, the text file, HTML file, and image file are shown, but the content file may be a file of any other format.

Also in the embodiment, the package management file and content file group management file are recorded in the data region 121 of the recording medium 120, but these management files may be also recorded in the protected region 122. As a result, risk of illegal alteration of management file by ill-willed user can be lowered, thus heightening security.

Further in the embodiment, the package is recorded as an archive file by the content file recording means 132, but the package demanded to be recorded in the content recording unit 130 from the input device 110 may be already an archive file, and the content file recording means 132 may receive the archive file and directly record in the data region 121.

(Fourth Embodiment)

A fourth embodiment of the invention is explained below. The configuration of the content recording/playback apparatus in the fourth embodiment is same as in the first embodiment (FIG. 1). However, an executable format file is also included, aside from the content file, in the package, and hence processing in the content playback unit is different from that in the first embodiment.

The content recording process and content playback process in the fourth embodiment are explained.

<Content Recording Process>

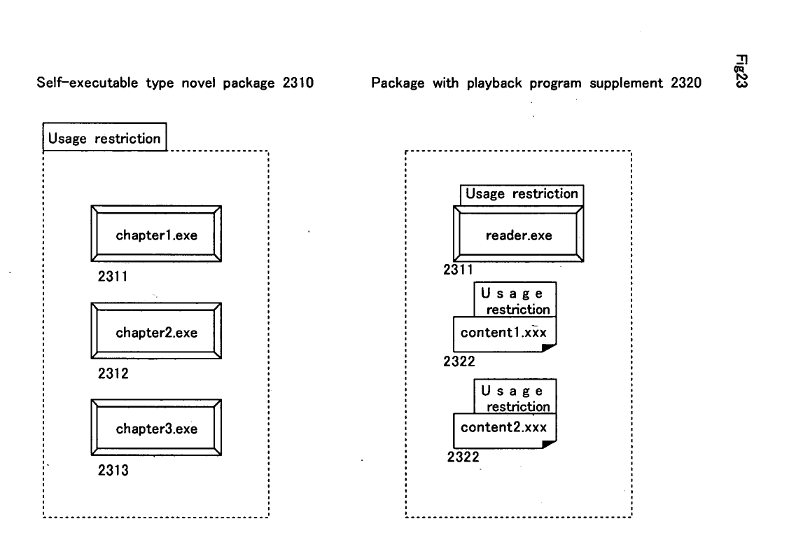

FIG. 23 shows an executable format novel package 2310 composed of executable format files 2311, 2312, 2313, and a playback program accessory package 2320 composed of executable format file 2321 and content files 2322, 2323.

The executable format files 2311, 2312, 2313 have file names chapter1.exe, chapter2.exe, and chapter3.exe, respectively. This is a package designed to playback chapter 1, chapter 2, and chapter 3 of the novel in self-executable format individually. In the executable format novel package 2310, the usage restriction is not set to each executable format file in the package, and the usage restriction is set only in the entire package 2310.

The executable format file 2321 has a file name reader.exe, and it is a program for playing back the content files 2322 and 2323. Herein, the content files 2322 and 2323 are files in a format which can only be played back in the executable format file 2321. In the playback program accessory package 2320, the usage restriction is set to each file in the package, and the usage restriction is not set to the entire package 2320.

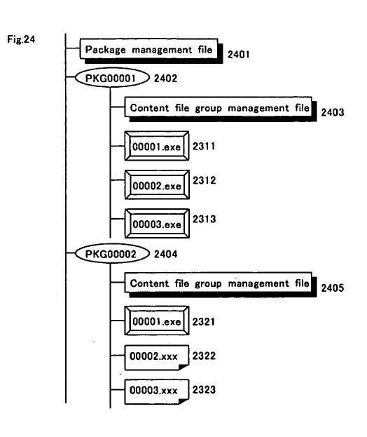

FIG. 24 is a diagram showing an example of directory and file configuration in the data region 121 of the recording medium 120 when two packages shown in FIG. 23 are recorded by the content recording unit 130.

The recording process in this embodiment is same as the processing flow of the first embodiment shown in FIG. 4 by handling the executable format file the same as the content file.

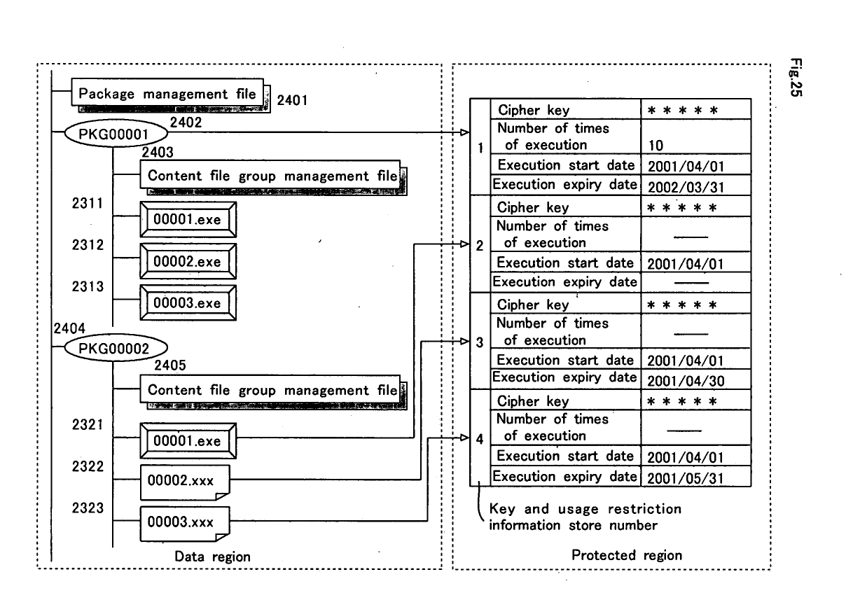

FIG. 25 is a diagram showing correspondence of each package, each content file contained therein, and key and usage restriction information, at the stage of reading in the recording medium 120 after completion of all content recording process shown in FIG. 4 in two packages shown in FIG. 23.

In FIG. 25, as the usage restriction information, three types are described, that is, the number of times of execution, the execution start date, and the execution expiry date. Herein, the number of times of execution is the limit number of times allowed to execute the executable format file, or play back the content file. The execution start date is the first day and time allowed to execute the executable format file, or view the content file. The execution expiry date is the final day and time allowed to execute the executable format file, or play back the content file. In the embodiment shown in FIG. 25, three types of usage restriction are presented, but this is only an example of usage restriction, and not limited to these three types of usage restrictions, other usage restrictions may be also set.

<Content Playback Process>

Suppose playback of the executable format file 2311 shown in FIG. 24 is requested through the input means 110.

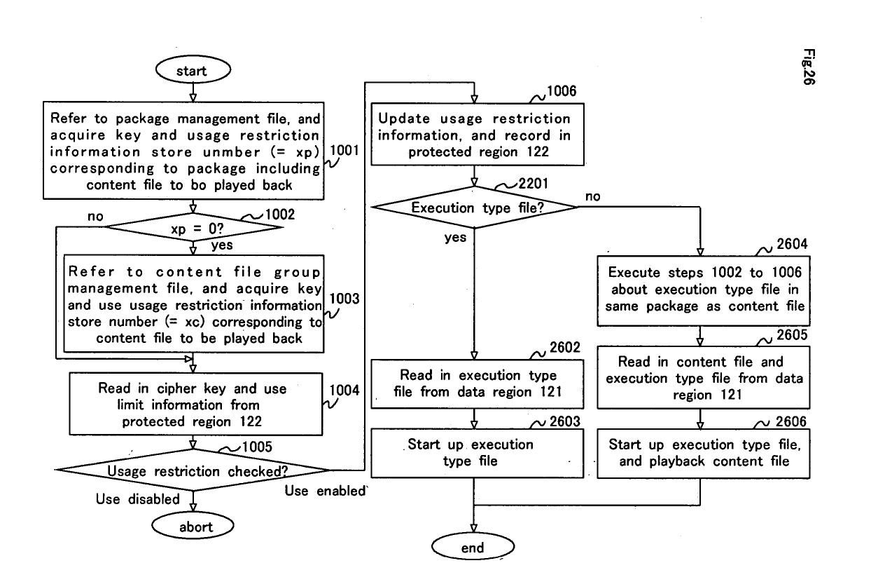

FIG. 26 is a diagram of content playback process flow in the content playback unit 140 in the fourth embodiment. The playback process of the executable format file 2311 is explained by referring to FIG. 26.

The process from step 1001 to step 1006 is the same as the process from step 1001 to step 1006 in the first embodiment in FIG. 10 by handling the executable format file the same as the content file.

Step 2601: When the file requested to be played back is an executable format file, the process goes to step 2602, and in the case of a content file, the process goes to step 2604. In this example, it is a playback request of executable format file 2311, and the process goes to step 2602.

Step 2602: The content file acquiring means 144 acquires the executable format file.

Step 2603: The content file playback means 145 decrypts and starts the execution of executable format file acquired at step 2602 by using the cipher key acquired at step 1004, and issues to the display device 150.

On the other hand, in the case of a playback request of content file 2322 shown in FIG. 24, the process is explained also in FIG. 26.

The process from step 1001 to step 1006 is the same as the process from step 1001 to step 1006 in the first embodiment in FIG. 10.

At step 2601, the playback of the content file 2322 is requested, and the process goes to step 2604.

Step 2604: The executable format file included in the same package as the content file of playback request is processed from step 1002 to step 1006. In this example, the executable format file 2321 shown in FIG. 24 is processed as mentioned above.

Step 2605: The content file acquiring means 144 acquires the content file and the executable format file designated to process at step 2604.

Step 2606: The content file playback means 145 decrypts the content file and executable format file acquired at step 2605, starts the execution of executable format file to play back the content file, and issues to the display device 150.

Thus, in this embodiment, in which the package is composed of content file and executable format file, the content file group management file for managing the files composing the content, the package management file for managing the file group as an integrated package, and the key and usage restriction information recorded in the protected region of the recording medium are provided, and the corresponding relation of the file and package, and the key and usage restriction information is recorded in the content file group management file and package management file, and the usage restriction information is recorded either in each file or the entire content depending on the content, so that the unit of provision or reference of the usage restriction information may be used selectively depending on the attribute of the content.

In the embodiment, the executable format file in the same package is created so that the appearance of the content being played back may change dynamically by selecting and combining arbitrary content files depending on the status at the time of playback (the present time or the like) from plural content file groups existing in the package.

(Fifth Embodiment)

A fifth embodiment is to realize the limit of use of the content in the content recording process in the recording medium in the content recording apparatus and content playback process in the content playback apparatus in the first embodiment to the fourth embodiment, by a program to be executed by a computer.

The processing flow of such a program is shown in the recording process flow in FIG. 4 and the playback process flow in FIG. 10, corresponding to the recording apparatus and playback apparatus in the first embodiment. Corresponding to the recording apparatus and playback apparatus in the second embodiment, the processing flow is shown in FIG. 14 and FIG. 18, and corresponding to the recording apparatus and playback apparatus in the third embodiment, the processing flow is shown in FIG. 20 and FIG. 22. Corresponding to the playback apparatus in the fourth embodiment, the playback process flow is shown in FIG. 26. Each step in these diagrams is explained in the first embodiment to the fourth embodiment.

(Sixth Embodiment)

A sixth embodiment relates to the recording medium which can store the content, key and usage restriction information, and the corresponding relation between the two in the content recording apparatus shown in the first embodiment and third embodiment. First, corresponding to the first embodiment, the recording medium for recording the content file is explained.

The recording medium refers to the medium having a region for protecting the security, and controlling data reading and writing, in addition to a region for recording the data. For example, SD (Secure Digital) memory card, and MMC (multimedia card) are known. Basically, the card has a region allowed to access only when validated, by the security realized by validation and encrypting, and the data to be protected (for example, the key for decoding the content) is stored in this area. The region allowed to access only when validated is called the protected region in this specification.

The recording medium comprises “a content file storing portion”, “a content file group management file portion”, and “a package management file portion”; each portion for composing the recording medium occupies part or whole of the data region, and, each file is stored.

“The content file storing portion” in the data region is a region for storing files of the content composed of plural files. The content is divided into plural files and stored for the convenience of management. That is, one content is established by combining individual files. For example, when the content is a novel, it is divided into files in each chapter, or when the content is a newspaper article composed of text and picture, it is divided into a text file (HTML file, etc.) and a picture file (image file).

The content file group management file portion in the data region is a region for storing management information of plural files. The file management information includes the information showing the corresponding relation between the file and the key and usage restriction information. For example, it corresponds to the key and usage restriction information store number provided in each file as shown in FIG. 6 or FIG. 8.

“The package management file portion” in the data region is a region for storing management information of package integrating plural files. The package is a set of content files, and the package management information includes the information showing the corresponding relation between the package and the key and usage restriction information. For example, it corresponds to the key and usage restriction information store number provided in each package as shown in FIG. 5 or FIG. 7.

The protected region is a region for storing-the key and usage restriction information storing both or one of the cipher key information and the usage restriction information of the files and package. This is the region allowed to access only when validated, and the security is protected.

The following are the methods of storing the corresponding relation of the files, the package, and the key and usage restriction information in the content file group management file portion and package management file portion.

<Method 1>

The package-itself and all of plural files for composing the package are stored so as to correspond to the same key and usage restriction information. For example, the content such as the novel divided into files in each chapter is entirely encrypted by a same key, or controlled to limit the number of times allowed to read all chapters.

<Method 2>

Plural files for composing the package are recorded so as to correspond to different key information each, and the package itself and all of plural files for composing the package are stored so as to correspond to the same usage restriction information. By possessing different cipher keys while sharing the same usage restriction information, the security level can be heightened. For example, in the case of a novel, by encrypting only the final chapter by a cipher key, it maybe controlled to charge a fee individually if desired to read the final chapter.

<Method 3>

Plural files for composing the package are recorded so as to each correspond to different key information, and the package itself and all of plural files for composing the package are stored so as to each correspond to different key and usage restriction information. The use can be controlled more specifically by adding plural pieces of usage restriction information to the files for composing the content.

These corresponding relations can be provided.

Meanwhile, the recording medium may correspond to the package, and the directory portion may be provided to store all files for composing the content. Since the directory portion stores all files, it should be included in the data region. By making use of the file system structure on the recording medium, the information necessary for package control can be lessened.

Further, at least one of the content file group management files and package management files may be created in the protected region. As a result, the security level can be heightened.

Relating to the third embodiment, the recording medium for storing the archive file integrating content files composed of plural files is explained.

The recording medium comprises “a content file storing portion” and “a package management file portion”. Each portion for composing the recording medium occupies part or whole of the data region, and stores each file, etc.

“The content file storing portion” in the data region is a region for storing the archive file integrating the files of the content composed of plural files. It is same as the content file storing portion mentioned above except that the files are integrated to be converted into an archive file.

“The package management file portion” in the data region is a region for storing the management information of the archive file. The management information of the archive is the information showing the corresponding relation between the archive file and the key and usage restriction information. “The package management file portion” may be put in the protected region. As a result, the security level can be heightened.

The protected region is a region for storing the key and usage restriction information storing both or one of the cipher key information and the usage restriction information of the archive file integrating content files composed of plural files. The protected region is the region allowed to access only when validated, and the security is protected.

The corresponding relation between the archive file and the key and usage restriction information can be stored in the package management file portion. By integrating plural files to assemble into an archive file, the region on the recording medium can be saved.

### INDUSTRIAL APPLICABILITY

As explained herein, according to the invention, when recording the files of the content composed of plural files in the recording medium, the content file group management file for managing the files composing the content, the package management file for managing the file group as an integrated package, and the key and usage restriction information recorded in the protected region of the recording medium are provided, and the corresponding relation of the file and package, and the key and usage restriction information is recorded in the content file group management file and package management file, and the usage restriction information is recorded either in each file or the entire content depending on the content, so that the unit of provision or reference of the usage restriction information may be used selectively depending on the attributes of the content.

Moreover, the corresponding relation between the files and package and the key and usage restriction information is recorded in both the content file group management file and the package management file, and the usage restriction information is recorded in both every file and package, the unit of provision or reference of usage restriction information can be dynamically changed over depending on the environments of use of the content.

Further, plural files for composing the content are integrated and recorded as an archive file, and by recording the corresponding relation between the archive file and the key and usage restriction information in the package management file, the content distributed in the integrated state can be recorded directly, and the processing efficiency is enhanced, and at the same time the region for recording medium can be saved.

1. A content recording apparatus for recording files of a content composed of plural files in a recording medium, comprising content file recording means for recording plural files for composing the content into the recording medium, management information recording means for recording a content file group management file storing management information of plural files and a package management file storing management information of the package compiling the plural files, and key and usage restriction information recording means for recording key and usage restriction information storing both or one of cipher key information and usage restriction information of the files and package in a protected region in the recording medium, wherein the corresponding relation between the files and package and the key and usage restriction information is recorded in the content file group management file and package management file.

2. The content recording apparatus according to claim 1, wherein when recording the corresponding relation between the files and package and the key and usage restriction information into the content file group management file and package management file, it is recorded so that the package itself and all of plural files for composing the package may correspond to the same key and usage restriction information.

3. The content recording apparatus according to claim 1, wherein when recording the corresponding relation between the files and package and the key and usage restriction information into the content file group management file and package management file, it is recorded so that each one of the plural files for composing the package may correspond to each different key information, and that the package itself and all of plural files for composing the package may correspond to the same usage restriction information.

4. The content recording apparatus according to claim 1, wherein when recording the corresponding relation between the files and package and the key and usage restriction information into the content file group management file and package management file, it is recorded so that each one of the plural files for composing the package may correspond to each different key information, and that the package itself and all of plural files for composing the package may correspond to each different usage restriction information.

5. The content recording apparatus according to any one of claims 1 to 4, wherein a directory corresponding to the package is created on the recording medium, and all files for composing the package are recorded in the directory.

6. The content recording apparatus according to any one of claims 1 to 5, wherein at least one of the content file group management files and package management files is created in a protected region on the recording medium.

7. A content recording apparatus for recording files of a content composed of plural files in a recording medium, comprising content file recording means for recording plural files for composing the content into the recording medium as an integrated archive file, management information recording means for recording a package management file storing the management information of the archive file, and key and usage restriction information recording means for recording key and usage restriction information storing both or one of cipher key information and usage restriction information of the archive file into a protected region in the recording medium, wherein the corresponding relation between the archive file and the key and usage restriction information is recorded in the package management file.

8. The content recording apparatus according to claim 7, wherein the package management file is created in the protected region on the recording medium.

9. A content playback apparatus for playing back the content from a recording medium in which a content composed of plural files is recorded, the recording medium storing a content file group management file storing the corresponding relation between the plural files for composing the content and the key and usage restriction information storing both or one of cipher key information and usage restriction information, and a package management file storing the corresponding relation between a package compiling the plural files for composing the content and the key and usage restriction information, with the key and usage restriction information being recorded in the protected region of the recording medium, comprising management information acquiring means for acquiring the corresponding relation between the file or package and the key and usage restriction information from the content file group management file or package management file, key and usage restriction information managing means for acquiring the key and usage restriction information, usage restriction judging means for judging permission or rejection of content playback by referring to the usage restriction information in the key and usage restriction information, content file acquiring means for acquiring the file of the content from the recording medium, and the content file playback means for playing back the acquired file of the content.

10. The content playback apparatus according to claim 9, wherein when the content playback is permitted by the usage restriction judging means, the key and usage restriction information managing means updates the usage restriction information of the corresponding content, and the content file acquiring means acquires the content file, then the content file playback means plays back the acquired file of the content.

11. The content playback apparatus according to claim 9 or 10, wherein the corresponding relation between the plural files or the package and the key and usage restriction information is recorded in either the content file group management file or the package management file in each content, and the management information acquiring means acquires the corresponding relation with the key and usage restriction information recorded in either the content file group management file or the package management file.

12. A content playback apparatus for playing back the content from a recording medium in which a content composed of plural files is recorded, the recording medium storing a content file group management file storing the corresponding relation between each file composing the content and the key and usage restriction information, and a package management file storing the corresponding relation between a package compiling the plural files for composing the content and the key and usage restriction information, with the key and usage restriction information being recorded in the protected region of the recording medium, comprising management information acquiring means for acquiring the corresponding relation between the file or package and the key and usage restriction information from the content file group management file or package management file, usage restriction selecting means for selecting to use which one of plural pieces of usage restriction information acquired from the management information acquiring means, key and usage restriction information managing means for acquiring the key and usage restriction information, usage restriction judging means for judging permission or rejection of content playback by referring to the usage restriction information in the key and usage restriction information, content file acquiring means for acquiring the file of the content from the recording medium, and the content file playback means for playing back the acquired file of the content, wherein the usage restriction judging means refers to the usage restriction information selected by the usage restriction selecting means.

13. The content playback apparatus according to claim 12, wherein when the content playback is permitted by the usage restriction judging means, the key and usage restriction information managing means updates the usage restriction information of the corresponding content, and the content file acquiring means acquires the content file, then the content file playback means plays back the acquired file of the content.

14. A content playback apparatus for playing back the content from a recording medium in which a content composed of plural files is recorded as one archive file integrating the plural files, the recording medium storing a package management file storing the corresponding relation between the archive file and the key and usage restriction information, with the key and usage restriction information being recorded in the protected region of the recording medium, comprising management information acquiring means for acquiring the corresponding relation between the archive file the key and usage restriction information from the package management file, key and usage restriction information managing means for acquiring the key and usage restriction information, usage restriction judging means for judging permission or rejection of content playback by referring to the usage restriction information in the key and usage restriction information, content file acquiring means for acquiring the file of the content from the recording medium, and the content file playback means for playing back the acquired archive file of the content.

15. The content playback apparatus according to claim 14, wherein when the content playback is permitted by the usage restriction judging means, the key and usage restriction information managing means updates the usage restriction information of the corresponding content, and the content file acquiring means acquires the content file, then the content file playback means plays back the acquired file of the content.

16. A medium having recorded a content use control program, being a medium in which a content use control program is recorded for controlling the use of content in a recording medium recording a file of content composed of plural files, characterized by making a computer execute a step of recording a content file group management file recording management information of plural files for composing the content, a step of obtaining plural files for composing the content by reading the content file group management file, a step of recording a package management file for managing plural files for composing the content as a package, a step of obtaining plural files compiled as a package by reading the package management file, and a step of controlling the use by the key and usage restriction information having both or one of cipher key information and usage restriction information of the files and package stored in a protected region of the recording medium, wherein the corresponding relation between the files and package and the key and usage restriction information is managed by the content file group management file and the package management file.

17. The medium having recorded a content use control program according to claim 16, wherein in the content file group management file and package management file for managing the corresponding relation between the files and package and the key and usage restriction information, the package itself and all of plural files for composing the package correspond to the same key and usage restriction information.

18. The medium having recorded a content use control program according to claim 16, wherein in the content file group management file and package management file for managing the corresponding relation between the files and package and the key and usage restriction information, each one of the plural files for composing the package corresponds to each different key information, and the package itself and all of plural files for composing the package corresponding to the same usage restriction information.

19. The medium having recorded a content use control program according to claim 16, wherein in the content file group management file and package management file for managing the corresponding relation between the files and package and the key and usage restriction information, each one of the plural files for composing the package corresponds to each different key information, and the package itself and all of plural files for composing the package correspond to the each different usage restriction information.

20. The medium having recorded a content use control program according to any one of claims 16 to 19, further characterized by making a computer execute a step of creating a directory corresponding to the package on the recording medium, wherein all files for composing the content are recorded in the directory.

21. The medium having recorded a content use control program according to any one of claims 16 to 20, further characterized by making a computer execute a step of creating at least one of the content data file group management file and package management file n a protected region on the recording medium.

22. A medium having recorded a content use control program, being a medium in which a content use control program in a recording medium for recording field of a content composed of plural files is recorded, characterized by making a computer execute a step of recording plural files for composing the content as an integrated archive file, a step of recording a package management file for managing the archive file, a step of obtaining the archive file from the package management file, a step of recording the key and usage restriction information storing the cipher key information and usage restriction information of the package in a protected region in the recording medium, and a step of controlling the use of the corresponding relation between the package and the key and usage restriction information by using the package management file.

23. The medium having recorded a content use control program according to claim 22, further characterized by making a computer execute a step of creating the package management file in the protected region on the recording medium.

24. A recording medium comprising a content file storing portion for storing files of a content composed of plural files, a content file group management file portion for storing management information of the plural files, a package management file portion for storing management information of a package compiling the plural files, and a protected region for storing key and usage restriction information storing both or one of cipher key information and usage restriction information of the files and package, wherein the corresponding relation between the files and package and the key and usage restriction information can be stored in the content file group management file portion and the package management file portion.

25. The recording medium according to claim 24, wherein when storing the corresponding relation between the files and package and the key and usage restriction information in the content file group management file and package management file, it is stored so that the package itself and all of plural files for composing the package may correspond to the same key and usage restriction information.

26. The recording medium according to claim 24, wherein when storing the corresponding relation between the files and package and the key and usage restriction information in the content file group management file and package management file, it is stored so that each one of the plural files for composing the package may correspond to each different key information, and that the package itself and all of plural files for composing the package may correspond to the same usage restriction information.

27. The recording medium according to claim 24, wherein when storing the corresponding relation between the files and package and the key and usage restriction information in the content file group management file and package management file, it is stored so that the plural files for composing the package may correspond to each different key information, and that the package itself and all of plural files for composing the package may correspond to each different key and usage restriction information.

28. The recording medium according to any one of claims 24 to 27, further comprising a directory for storing all of files for composing the content, corresponding to the package.

29. The recording medium according to any one of claims 24 to 28, wherein at least one of the content file group management file portion and package management file portion is created in a protected region.

30. A recording medium comprising a content file storing portion for storing a content composed of plural files as an integrated archive file, a package management file portion for storing management information of the archive file, and a protected region for storing key and usage restriction information storing both or one of cipher key information and usage restriction information of the archive file, wherein the corresponding relation between the archive file and the key and usage restriction information can be stored in the package management file portion.

31. The recording medium according to claim 30, wherein the package management file is created in the protected region.
